(19) United States
(12) Patent Application Publication
(10) Pub. No.: US 2012/0127172 A1
(43) Pub. Date: May 24, 2012

(54) SYSTEMS AND METHODS FOR IMAGE REFINEMENT USING CIRCUIT MODEL OPTIMIZATION

(75) Inventors: Chun-Te WU, Taoyuan County (TW); Chia-Hang Ho, Taipei City (TW); Feng-Hsiang Lo, Hsinchu County (TW); Wei-Jia Huang, Nantou County (TW)

(73) Assignee: Industrial Technology Research Institute, Hisnchu (TW)

(21) Appl. No.: 13/339,136

(22) Filed: Dec. 28, 2011

Related U.S. Application Data
(63) Continuation-in-part of application No. 13/152,093, filed on Jun. 2, 2011.
(60) Provisional application No. 61/374,735, filed on Aug. 18, 2010.

(30) Foreign Application Priority Data
Dec. 24, 2010 (TW) 99145926

(51) Int. Cl. G06T 15/00

(52) U.S. Cl. 345/419

(57) ABSTRACT

A method for refining a three-dimensional image includes identifying a depth image of the three-dimensional image, and establishing a simulation circuit model by a processor. The simulation circuit model includes data nodes, diffusion nodes and connection devices, the connection devices connecting the data nodes and the diffusion nodes, the simulation circuit model assigning emulation voltage signals to the data nodes, the assigned emulation voltage signals being substantially correlated to depth data. The processor applies an optimization operation to generate diffused voltage signals for the diffusion nodes due to at least a redistribution of at least some of the emulation voltage signals to the diffusion nodes through the connection devices, and updates the depth data of the depth image based on the diffused voltage signals.

### CROSS REFERENCES TO RELATED APPLICATIONS

This application is a continuation-in-part of commonly-assigned, co-pending application U.S. patent application Ser. No. 13/152,093, filed Jun. 2, 2011, which claims the benefit of priority from U.S. Provisional Application No. 61/374,735, filed Aug. 18, 2010, and Taiwan Patent Application Serial No. 99145926, filed Dec. 24, 2010. These applications are hereby incorporated by reference into this application in their entirety.

### FIELD OF THE INVENTION

This disclosure relates to systems and methods for refining three-dimensional images, including systems and methods for refining three-dimensional images using circuit model operation or optimization.

### BACKGROUND

Multimedia technologies, including those for video- and image-related applications, are widely used in various fields, such as entertainment, education, medical diagnosis, and business presentations. For example, the entertainment industry is presenting more and more contents with three-dimensional (“3D”) images and videos. Various image-based rendering methods are used to render the 3D presentations. For example, a 3D image can be rendered based on a set of two-dimensional (2D) images and their associated depth images that indicate how far each pixel of the respective 2D images is from a viewpoint.

Three-dimensional rendering relies on the depth image with sufficient quality. As an illustrative and non-restrictive example, poor quality in depth image(s) may cause conflicts between monocular and binocular cues, which may cause viewers' visual discomfort. For instance, viewer may feel eyestrain, headache, or other painful 3D-related sickness. Depth Image based Rendering (DIBR) methods that are currently available do not correct such conflicts of depth cues that are caused by poor or incorrect depth images.

Therefore, it may be desirable to have systems, methods, or a combination thereof that refines the depth images before the three-dimensional image is rendered based thereon.

### SUMMARY

The disclosed embodiments provide a computer-implemented method for refining a three-dimensional image. The method identifies a depth image of the three-dimensional image, and establishes a simulation circuit model. The simulation circuit model includes data nodes, diffusion nodes and connection devices. The connection devices connect the data nodes and the diffusion nodes. The simulation circuit model assigns emulation voltage signals to the data nodes corresponding to at least a portion of the data points in the depth image. The assigned emulation voltage signals are substantially correlated to depth data of the at least a portion of the data points. The method further applies an optimization operation to generate diffused voltage signals for the diffusion nodes due to at least a redistribution of at least some of the emulation voltage signals to the diffusion nodes through the connection devices. The method also updates the depth data of the depth image based on the diffused voltage signals.

The disclosed embodiments further provide another computer-implemented method for refining a three-dimensional image. The method identifies a depth image of the three-dimensional image. The method further determines an energy including a first energy portion corresponding to a depth constraint, a second energy portion corresponding to a distortion constraint, and a third energy portion corresponding to an edge bending constraint. The depth constraint, the distortion constraint, and the edge bending constraint are each a function of depth data of the depth image. The method then applies an optimization operation to refine the depth data of the depth image by at least one of reducing minimizing the energy.

The disclosed embodiments also provide a system for refine a three-dimensional image. The system includes a storage device storing a depth image of the three-dimensional image. The depth image includes a depth data. The system further includes a processor coupled with the storage device. The processor is configured to establish a simulation circuit model. The simulation circuit model includes data nodes, diffusion nodes and connection devices. The connection devices connect the data nodes and the diffusion nodes. The simulation circuit model assigns emulation voltage signals to the data nodes corresponding to at least a portion of the data points in the depth image. The assigned emulation voltage signals are substantially correlated to depth data of the at least a portion of the data points. The processor is further configured to apply an optimization operation to generate diffused voltage signals for the diffusion nodes due to at least a redistribution of at least some of the emulation voltage signals to the diffusion nodes through the connection devices. The processor is also configured to update the depth data of the depth image based on the diffused voltage signals.

The disclosed embodiments further provide a system for refining a three-dimensional image. The system includes a storage device storing a depth image of the three-dimensional image. The depth image includes a depth data. The system further includes a processor coupled with the storage device. The processor is configured to determine an energy including a first energy portion corresponding to a depth constraint, a second energy portion corresponding to a distortion constraint, and a third energy portion corresponding to an edge bending constraint. The depth constraint, the distortion constraint, and the edge bending constraint are each a function of depth data of the depth image. The processor is further configured to apply an optimization operation to refine the depth data of the depth image by at least one of reducing or minimizing the energy.

The disclosed embodiments further provide a non-transitory computer-readable medium with an executable program stored thereon, wherein the program instructs a processor to perform a method for refining a three-dimensional image. The method identifies a depth image of the three-dimensional image, and establishes a simulation circuit model. The simulation circuit model includes data nodes, diffusion nodes and connection devices. The connection devices connect the data nodes and the diffusion nodes. The simulation circuit model assigns emulation voltage signals to the data nodes corresponding to at least a portion of the data points in the depth image. The assigned emulation voltage signals are substantially correlated to depth data of the at least a portion of the data points. The method further applies an optimization operation to generate diffused voltage signals for the diffusion nodes due to at least a redistribution of at least some of the emulation voltage signals to the diffusion nodes through the connection devices. The method also updates the depth data of the depth image based on the diffused voltage signals.

The disclosed embodiments further provide another non-transitory computer-readable medium with an executable program stored thereon, wherein the program instructs a processor to perform a method for refining a three-dimensional image. The method identifies a depth image of the three-dimensional image. The method further determines an energy including a first energy portion corresponding to a depth constraint, a second energy portion corresponding to a distortion constraint, and a third energy portion corresponding to an edge bending constraint. The depth constraint, the distortion constraint, and the edge bending constraint are each a function of depth data of the depth image. The method then applies an optimization operation to refine the depth data of the depth image by at least one of reducing minimizing the energy.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate disclosed embodiments described below.

In the drawings,

FIG. 1 shows an exemplary three-dimensional image processing system, consistent with certain disclosed embodiments;

FIG. 2 shows a flow chart of an exemplary process for refining a depth image using a simulation circuit model, consistent with certain disclosed embodiments;

FIG. 3 illustrates an exemplary simulation circuit model, consistent with certain disclosed embodiments;

FIG. 4 illustrates an exemplary sub-circuit model, consistent with certain disclosed embodiments;

FIG. 5 shows a flow chart of an exemplary process for refining a depth image using saliency constraints, consistent with certain disclosed embodiments;

FIG. 6 shows a flow chart of an exemplary process for refining a depth image using the simulation circuit model and saliency constraints, consistent with certain disclosed embodiments;

and

FIG. 7 shows a flow chart of an exemplary process for refining a depth image using the simulation circuit model followed by a separate optimization using saliency constraints, consistent with the disclosed embodiments.

### DESCRIPTION OF THE EMBODIMENTS

Reference will now be made in detail to the exemplary embodiments of the disclosure, examples of which are illustrated in the accompanying drawings. Wherever possible, the same reference numbers will be used throughout the drawings to refer to the same or like parts.

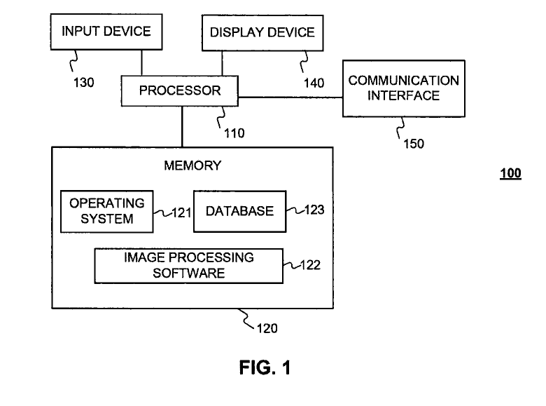

FIG. 1 shows an exemplary 3D image processing system 100. Consistent with some embodiments, 3D image processing system 100 may be configured to render 3D images from a set of 2D images and one or more associated depth images. In some embodiments, 3D image processing system 100 may be configured to refine the depth images, the 2D images, or a combination thereof, before 3D rendering to improve the visual quality of the 3D synthetic images.

Consistent with some embodiments, 3D image processing system 100 may include a processor 110, a memory or memory module 120, a user input device 130, a display device 140, and a communication interface 150. Processor 110 can be a general processor (such as one of the ARM® processors), a central processing unit (“CPU”), an application-specific integrated circuit (“ASIC”), a graphic processing unit (“GPU”), or any combination thereof. Depending on the type of hardware being used, processor 110 can include or be coupled with one or more printed circuit boards that have one or more microprocessor chips. Processor 110 can execute sequences of computer program instructions to perform various methods, including the exemplary ones described below.

Memory 120 can include, among other things, a random access memory (“RAM”), a read-only memory (“ROM”), a flash memory, or any combination thereof. The computer program instructions can be accessed and read from a ROM, a flash memory, or any other suitable location and loaded into the RAM for execution by processor 110. For example, memory 120 may store one or more software applications. Software applications stored in memory 120 may comprise operating system 121 for one or more processors or one or more common computer systems as well as for one or more software-controlled devices. Further, memory 120 may store the software application or only a part of the software application that is executable by processor 110. In some embodiments, memory 120 may store image processing software 122 that may be executed by processor 110. For example, image processing software 122 may be executed to refine the depth images.

Image processing software 122 or portions of it may be stored on a removable computer readable medium, such as a hard drive, computer disk, CD-ROM, DVD ROM, CD±RW or DVD±RW, flash memory, USB flash drive, memory stick, or any other suitable medium, and may run on any suitable component of 3D image processing system 100. For example, portions of applications to perform image processing may reside on a removable computer readable medium and be read and acted upon by processor 110 using routines that have been copied to memory 120.

In some embodiments, memory 120 may also store master data, user data, application data, program code, or any combination thereof. For example, memory 120 may store a database 123 having various image data such as the depth data of the depth images and the pixel values of the 2D images.

In some embodiments, input device 130 and display device 140 may be coupled to processor 110, such as through an appropriate interface or interface circuitry. In some embodiments, input device 130 may be a hardware keyboard, a keypad, a touch screen, or any combination thereof, through which an authorized user may input information to 3D image processing system 100. Display device 140 may include one or more display screens that display the various images or any related information to the user. For example, display device 140 may display the rendered 3D images, and/or the intermediate 2D images and depth images.

Communication interface 150, in some embodiments, may enable image processing system 100 to exchange data with one or more external devices. Consistent with some embodiments, communication interface 150 may include a network interface, a universal serial bus (USB), a HDMI port, etc. and may be (not shown) configured to receive 3D images, such as 2D image data and depth data, from an image acquisition device, such as a 3D camera. Consistent with some embodiments, communication interface 150 may also be configured to send 3D image data to a remote display device.

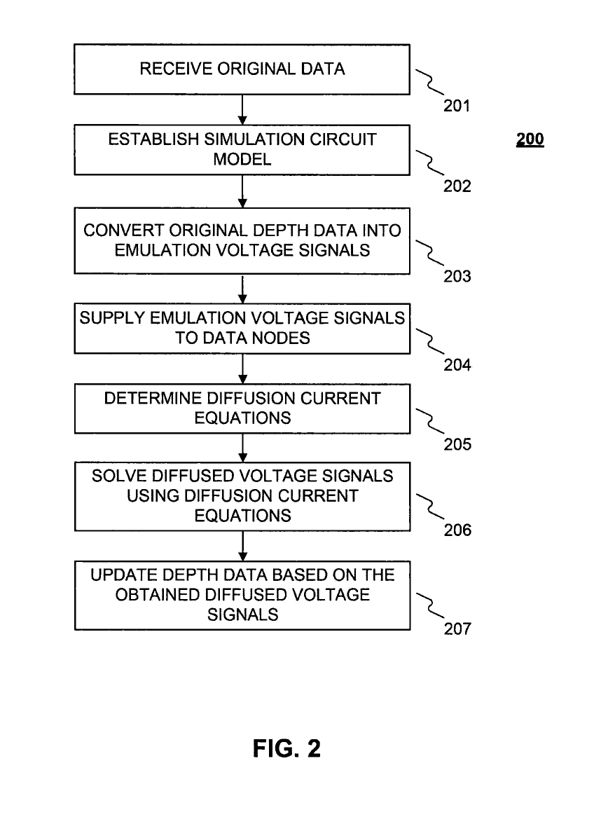

One or more components of 3D image processing system 100 may be used to implement a process related to 3D image processing. For example, FIG. 2 shows a flow chart of an exemplary process 200 for refining a depth image using a simulation circuit model. Process 200 may begin by receiving original data (step 201). For example, the original data may be recorded by a 3D camera and received by 3D image processing system 100 through communication interface 150. In some embodiments, the original data may include 2D image data DV and original depth data Di corresponding to the 2D image data DV. The 2D image data DV may contain luminance or color information of the scene objects. Depth data Di, also known as a depth map or depth image, may contain information relating to the distance (or the suggested distance) of the surfaces of scene objects from a viewpoint. For example, depth data Di may include m×n data values Di(1,1), Di(1,2), Di(1,3), . . . , Di(m,n) for m×n data points, and the 2D image data DV may include m×n pixel values I(1,1), I(1,2), . . . , I(m,n) for those same (or substantially same) data points. In some other embodiments, the 2D image data DV may have more or less data points than those of the depth data Di. The m×n original depth data values Di(1,1)-Di(m,n) respectively correspond to the m×n pixel values I(1,1)-I(m,n) and indicate the respective distances from these pixels to a viewpoint.

In some embodiments, the depth data may have a larger value when the object is nearer to the viewpoint. For example, the m×n original depth data Di(1,1)-Di(m,n) may each include 8-bits. In other words, each of the original depth data Di(1,1)-Di(m,n) has a numeric value ranging between 0-255. The greater the values the original depth data Di(1,1)-Di(m,n) are, the lesser depths the corresponding pixel value I(1,1)-I(m,n) have. Conversely, the smaller values the depth data Di(1,1)-Di(m,n) are, the greater depths the corresponding pixel value I(1,1)-I(m,n) have. When the depth data is represented by a grayscale image, the nearer object may be represented by a lighter gray.

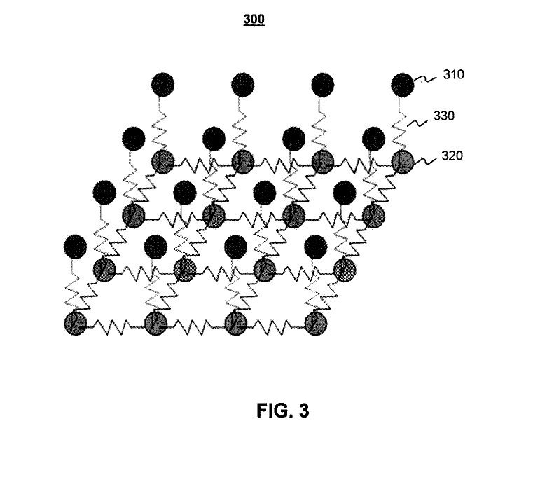

In step 202, a simulation circuit model may be established. For example, FIG. 3 illustrates an exemplary simulation circuit model 300. Simulation circuit model 300 is a modeling concept that may include data nodes 310, diffusion nodes 320, and connection devices 330 as part of the model. Connection devices 330 may be coupled (and conceptually, electrically coupled) between the data nodes 310 and the respective adjacent diffusion nodes 320, such that a current may flow between data nodes 310 and diffusion nodes 320. Connection devices 330 may also be coupled between two adjacent diffusion nodes 320, such that a current may flow between the diffusion nodes.

In some embodiments, the number of data nodes 310 and diffusion nodes 321 may be equal to, less than, or more than the number of original depth data values. In one embodiment, m×n data nodes 310 and m×n diffusion nodes 320 may be established in simulation circuit model 300 based on the m×n original depth data values Di(1,1−)-Di(m,n) received in step 201.

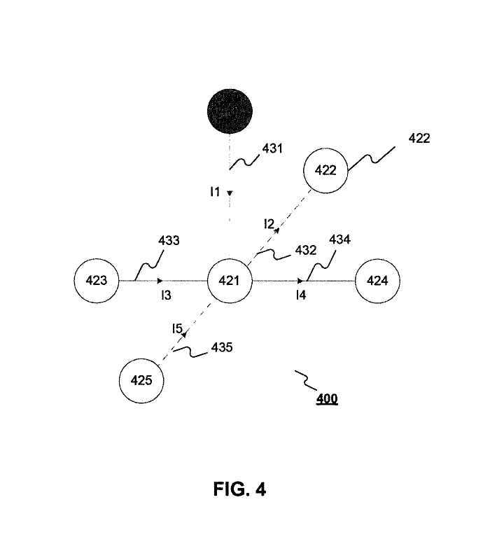

Accordingly, the simulation circuit model 300, as illustrated in FIG. 3, may include m×n sub-circuit models M(1,1), M(1,2), . . . , M(m,n) having repeating or similar circuit structures. The m×n sub-circuit models M(1,1), M(1,2), . . . , M(m,n) may respectively correspond to or be substantially correlated to the m×n original depth data values Di(1,1)-Di(m,n). For example, FIG. 4 illustrates an exemplary sub-circuit model M(i,j) 400, which is substantially correlated to the original depth data Di(i,j), wherein i and j are a natural number smaller than or equal to m and a natural number smaller than or equal to n, respectively.

As shown in FIG. 4, the sub-circuit model M(i,j) 400 may include a data node NS(i,j) 410, a number of diffusion nodes ND(i,j) 421, ND(i−1,j) 422, ND(i,j−1) 423, ND(i,j+1) 424, and ND(i+1,j) 425, and a number of connection devices 431-435. In some embodiments, connation device 431, coupled between data node 410 and diffusion node 421 may be a spatial data diffused connection device RS. Connation devices 432-435, coupled between diffusion node 421 and its adjacent diffusion nodes 422-425, may be diffused connection devices RD1-RD4. In some embodiments, connection devices 431-435 may be resistance model elements. When different voltage potentials present on the two nodes connected by a certain connection device, a diffusion current may flow on the connection device.

Referring back to FIG. 2, the original depth data may be converted into emulation voltage signals (step 203). For example, processor 110 may generate m×n converted emulation voltage signals SV(1,1), SV(1,2), . . . , SV(m,n), based on the m×n original depth data Di(1,1)-Di(m,n). In some embodiments, processor 110 may use the numeric values of the depth data as the value of the emulation voltage signals or use derived or converted values. In some other embodiments, processor 110 may generate voltage values proportional to the numerical values.

In step 204, the emulation voltage signals may be supplied to the data nodes. For example, emulation voltage signals SV(1,1), SV(1,2), . . . , SV(m,n) may be supplied to data nodes NS(1,1), NS(1,2), . . . , NS(m,n), respectively. Because diffusion nodes ND(1,1), ND(1,2), . . . , ND(m,n) each have a zero voltage potential, a diffusion current may occur between each data node NS(i,j) and its corresponding diffusion node ND(i,j). For example, as shown in FIG. 4, a diffusion current Il may flow from data node 410 to diffusion node 421, increasing the voltage potential on diffusion node 421. Similarly, the voltage potentials on diffusion nodes 422-425 may be increased due to the diffusion currents flowing from their respective data nodes (not shown). Depending on the relative value of the voltage potentials on diffusion nodes 421 and its adjacent diffusion nodes 425, diffusion currents may flow between diffusion nodes 421 and 422-425. For example, as shown in FIG. 4, diffusion current I2 may flow from diffusion node 421 to diffusion node 422, diffusion current I3 may flow from diffusion node 423 to diffusion node 421, diffusion current I4 may flow from diffusion node 421 to diffusion node 424, and diffusion current IS may flow from diffusion node 425 to diffusion node 421.

Referring back to FIG. 2, a diffusion current constraint may be determined (step 205). As part of step 205, the resistance values of the connection devices 330 may be determined. In some embodiments, the resistance values Rs of the spatial data diffused connection devices RS(1,1)-RS(m,n) may be substantially equal. For example, the resistance values may be determined and input by the user via input interface 130. In some embodiments, the resistance value Rd of each of the diffused connection devices, such as RD1-RD4 of the sub-circuit model 400 may be determined by the following equation:

$$Rd = \frac{α}{{e}^{- ( β {‖ {C}_{t} - {C}_{n} ‖}^{2} )}} \qquad ( 1 )$$

where, α and β denote predetermined parameters; Cₜ denotes the color information of the corresponding pixel data DV(i,j) of the original depth data Di(i,j); Cₙ denotes the color information of the corresponding pixel data of each of the original depth data on the diffusion nodes (e.g., ND(i−1,j), ND(i,j−1), ND(i,j+1) and ND(i+1,j)) coupled by the diffused connection devices RD1-RD4. Consistent with some embodiments, the color information Cₜ and Cₙ of the pixel data can be obtained from the sum of the absolute values of the sub-pixel data of each color of the corresponding pixel data.

Accordingly, as part of step 205, diffusion currents may be determined using Ohm's law, as the potential difference across the respective connection devices divided by the respective resistance values of the connection devices. For example, diffusion current I₁-I₅ of FIG. 4 may be determined as:

$$\begin{matrix}{I}_{1} = \frac{{V}_{410} - {V}_{421}}{Rs} & ( 2 ) \\ {I}_{2} = \frac{{V}_{412} - {V}_{422}}{{Rd}_{432}} & ( 3 ) \\ {I}_{3} = \frac{{V}_{423} - {V}_{421}}{{Rd}_{433}} & ( 4 ) \\ {I}_{4} = \frac{{V}_{421} - {V}_{424}}{{Rd}_{434}} & ( 5 ) \\ {I}_{5} = \frac{{V}_{425} - {V}_{421}}{{Rd}_{435}} & ( 6 )\end{matrix}$$

where, V₄₁₀ is the supplied emulation voltage signal on data node 410, and V₄₂₁-V₄₂₅ are unknown diffused voltage signals.

According to Kirchhoff's current law, at any node in an electrical circuit, the sum of currents flowing into that node is equal to the sum of currents flowing out of that node. Take diffusion node 421 as an example, diffusion currents I₁, I₃, and I₅ flow into the node, and I₂ and I₄ flow out of it. Therefore, under Kirchhoff's current law, the diffusion currents should satisfy the diffusion current equation as follow:

I₁+I₃+I₅−I₂−I₄=0 (7)

Consistent with some embodiments, diffusion current equations similar to Equation (7) may be determined for all the diffusion nodes in the simulation circuit model.

Referring back to FIG. 2, the diffused voltage signals may be solved using the diffusion current equations (step 206). In some embodiments, processor 110 may construct a matrix equation Ax=b with the equations similar to Equation (7), where matrix A is a matrix of diffusion currents, vector x is an unknown vector of diffused voltage signals, and vector b may contain known values. For example, the following solution may be obtained for the diffused voltage signals:

x=(AA^{H})⁻¹b (8)

In the exemplary solution as shown in Equation (8), the diffused voltage signals may be determined as a least square matrix solution. However, it is contemplated that other solutions may also be used.

For example, the matrix equation Ax=b may also be solved using iterative methods, or optimization methods as to minimize the difference between Ax and b. Iterative methods solve the optimization in an iterative manner, where in each iteration, the unknowns are adjusted using a gradient of the cost function (e.g., |Ax−b|), and then the cost function is updated based on the adjusted unknowns. In each iteration, the value of the cost function may be reduced compared to the previous iteration. The iterations continue until the cost function satisfies a predetermined criterion. For example, iterations may stop when |Ax−b| is below a predetermined threshold. Various iterative methods, such as Newton methods, Conjugate Gradient methods, Gradient descent methods, Subgradient methods, Gauss-Seidel methods, multi-grid methods, etc., may be used.

As a result of the optimization operation, diffused voltage signals on the respective diffusion nodes 320 may be obtained. The diffused voltage signals reflect the redistribution of the emulation voltage signals supplied to the data nodes 310 in step 204. For example, in a simulation circuit model that has m×n diffusion nodes ND(1,1)-ND(m,n), m×n diffused voltage signals SVD(1,1), SVD(1,2), . . . , SVD(m,n) may be respectively obtained.

Referring back to FIG. 2, the original depth data may be updated based on the obtained diffused voltage signals (step 207). For example, a new set of depth data Do(1,1), Do(1,2), . . . , Do(m,n) may be determined based on diffused voltage signals SVD(1,1), SVD(1,2), . . . , SVD(m,n). In some embodiments, the numerical values of SVD(1,1), SVD(1,2), . . . , SVD(m,n) may be used directly as the voltage signal values. In some other embodiments, the numerical values may be normalized within the range of 0-255. Process 200 may conclude after step 207.

Consistent with some embodiments, process 200 may sharpen the edges of scene objects due to the diffusion effect of the simulation circuit model. For example, using the simulation circuit model, voltages within the status are trapped inside the color boundary, and voltages outside the status diffuse, which sharps the object edge depth. Accordingly, foreground fatten effect may be reduced, and scattered local errors may also be smoothed.

Although FIG. 2 is described using exemplary embodiments above, application of the described process is not limited to these embodiments. It is contemplated that the described process is applicable to various other embodiments of original data, simulation circuit models, resistance values, and diffusion current constraints, such as those disclosed in U.S. patent application Ser. No. 13/152,093 filed Jun. 2, 2011, which is incorporated by reference in its entirety.

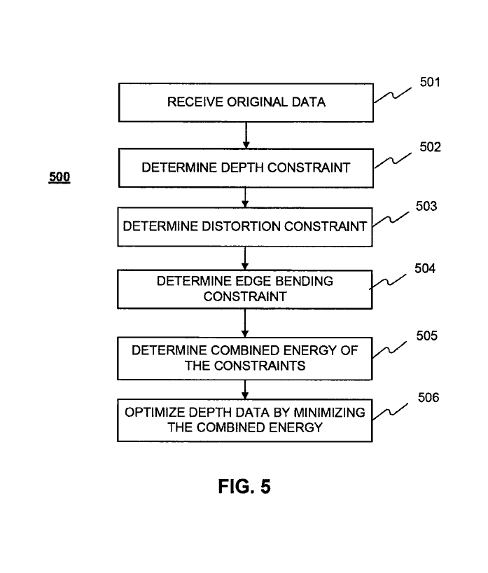

FIG. 5 shows a flow chart of an exemplary process 500 for refining a depth image using saliency constraints. Process 500 may start when original data is received (step 501), similar to step 201 described in connection with process 200. In some embodiments, process 500 is used to determine a warping map of refined depth w. Warping is a process that projects one or more 2D images into a 3D image space based on the corresponding depth maps. It is a method to render a synthetic image (i.e., a 3D image). A high quality synthetic image should ideally have several features, such as less depth errors, less distortion effects, and less edge bending areas. Accordingly, consistent with some embodiments, process 500 aims to determine a warping map of refined depth that results in a synthetic image having optimized image features. For example, processor 110 may determine various saliency constraints for the warping map in steps 502-503, and solve the optimized warping map with respect to the saliency constraints in steps 505-506.

In step 502, a depth constraint may be determined for the warping map. Ideally, the difference between the warping map and the depth map is the corresponding axis value. Using x-axis as an example, the depth constraint may be determined as:

wₓ−x−d_{i,j}=0 (9)

where wₓ is the x-axis component of a warping form of a refined depth, x is the corresponding value of x axis, and d_{i,j} is the original depth data of the (i,j) image pixel. Depth constraints for other axes may be determined similarly.

In step 503, a distortion constraint may be determined for the warping map. The distortion constraint is to limit the edge distortions. Again, using x-axis as an example, the distortion constraint may be determined as:

$$\frac{\partial {ω}_{x}}{\partial x} = 1 \qquad ( 10 )$$

where wₓ is the x-axis component of a warping form of a refined depth, and x is the corresponding value of x axis. Distortion constraints for other axes may be determined similarly.

In step 504, an edge bending constraint may be determined for the warping map. The edge bending constraint is to limit the edge bendings, and thus involves at least two axes. Ideally the gradient of the warping map over another dimension is zero. Using x-axis as an example, the distortion constraint may be determined as:

$$\frac{\partial {ω}_{x}}{\partial y} = 0 \qquad ( 11 )$$

where wₓ is the x-axis component of a warping form of a refined depth, and y is the corresponding value of y axis. Distortion constraints for other axes may be determined similarly.

In step 505, a combined energy may be determined based on at least one of the depth constraint, distortion constraint, and edge bending constraint. In some embodiments, the combined energy may be determined as a total energy including three portions:

Eₜₒₜₐₗ=λ_{d}E_{D}+λ_{d}E_{d}+λ_{b}E_{b} (12)

E_{D}=∫ₓ(wₓ−x−dᵢ)dx (13)

$$\begin{matrix}{E}_{d} = {\int }_{x}^{ } {S ( \frac{\partial {ω}_{x}}{\partial x} - 1 )}^{2} d x & ( 14 ) \\ {E}_{b} = {\int }_{x}^{ } {S ( \frac{\partial {ω}_{y}}{\partial x} )}^{2} d x & ( 15 )\end{matrix}$$

where Eₜₒₜₐₗ is the combined energy of constraints, E_{D} is the energy from depth constraint, E_{d} means energy from image distortion constraint, E_{b} means energy from edge bending constraint, and λ_{D}, λi_{d}, λ_{b} are the weights of E_{D}, E_{d} and E_{b}, respectively.

In some embodiments, each of the energy E_{D}, E_{d} and E_{b} may be determined as sum of squares (i.e., second order norm) of the respective constraints, as in Equations (13)-(15). However, it is contemplated that any other order norms may also be used.

In some embodiments, the weights λ_{D}, λ_{d} , λ_{b} may be fixed and pre-programmed into processor 110. In some embodiments, processor 110 may adaptively determine the weights λ_{D}, λ_{d}, λ_{b} based on the relative significances of depth distortion, edge distortion, and edge bending in each particular synthetic image. For example, λ_{d} may be set relatively larger, if significant edge distortion occurs in the synthetic image. In some cases, one or more of weights λ_{D}, λ_{d} , λ_{b} may be set as zero such that the respective constraints are removed from the combined energy. In some other embodiments, the weights may be determined and input by the user via input interface 130.

In step 506, the warping map may be solved by reducing or minimizing the combined energy determined in step 505. In some embodiments, the following optimization operation may be performed for the warping map that results in a minimum energy Eₜₒₜₐₗ:

arg min_{D}(Eₜₒₜₐₗ=λ_{D}E_{D}+λ_{d}E_{d}+λ_{b}E_{b}) (16)

Like the optimization operation of Equation (8), the optimization operation of Equation (16) may also be performed using various algorithms that are known to the skilled in the art. As a result of the optimization, a warping map of refined depth may be obtained. Process 500 may conclude after step 506.

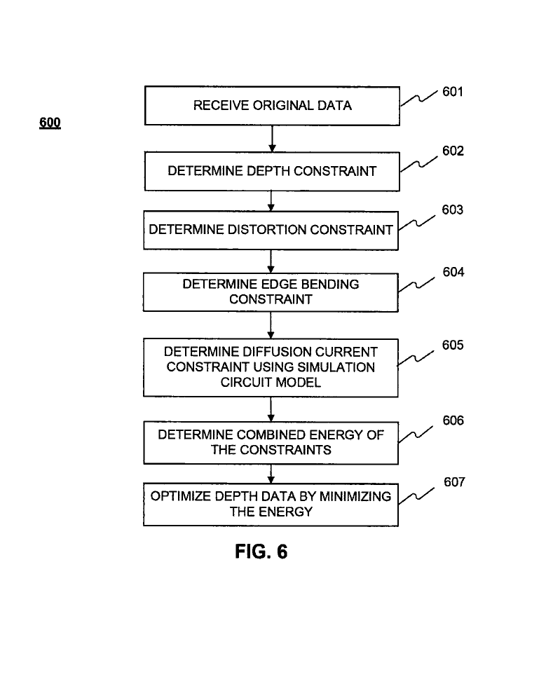

FIG. 6 shows a flow chart of an exemplary process 600 for refining a depth image using the simulation circuit model and saliency constraints. In some embodiments, steps 601-604 may be performed similar to steps 501-504 as described above in connection with process 500. In step 605, diffusion current constraints may be determined using a simulation model. In some embodiments, step 605 may be performed similar to steps 202-205 as described above in connection with process 200.

In step 606, a combined energy may be determined based on at least one of the depth constraint, distortion constraint, and edge bending constraint. In some embodiments, the combined energy may be determined as a total energy including three portions:

Eₜₒₜₐₗ=λ_{D}E_{D}+λ_{d}E_{d}+λ_{b}E_{b}+λ_{c}E_{c} (17)

where energy

$$\begin{matrix}{E}_{c} = {\int }_{x}^{ } ( \frac{{V}_{n + 1} - {V}_{n}}{R} ) d x \\ = {\int }_{x}^{ } \frac{{e}^{- ( β {‖ {C}_{t} - {C}_{n} ‖}^{2} )}}{α} ( {d}_{n + 1} - {d}_{n} ) d x\end{matrix} \qquad ( 18 )$$

where d is the depth and n denotes the n-th pixel, and E_{D}, E_{d} and E_{b} are as defined in Equations (13)-(15), respectively, and k , λ_{D}, λ_{d}, λ_{b} are the weights of E_{c}, E_{D}, E_{d} and E_{b}, respectively. Although Equation (17) shows all four energy portions, it is contemplated that the combined energy may include less energy portions by adjusting the weights λ_{c} , λ_{D} , λ_{d} , λ_{b} .

In step 607, the warping map may be solved by reducing or minimizing the combined energy determined in step 606. In some embodiments, the following optimization operation may be performed for the warping map that results in a minimum energy Eₜₒₜₐₗ:

arg min_{D}(Eₜₒₜₐₗ=λ_{D}E_{D}+λ_{d}E_{d}+λ_{b}E_{b}+λ_{c}E_{c}) (19)

Methods for performing optimization operation of Equation (19) are similar to those described for solving Equations (8) and (16). As a result of the optimization, a warping map of refined depth may be obtained and process 600 may conclude after step 607.

Process 600 essentially combines process 200 and process 500 in a manner that an optimization cost function is a combination of the cost functions used in the respective processes. As a result, an optimization based on the simulation circuit model and an optimization based on saliency constraints are performed in one combined optimization step. Consistent with some embodiments, process 600 may smooth the depth errors by diffusion within similar color, as well as limiting distortion and bending constraints.

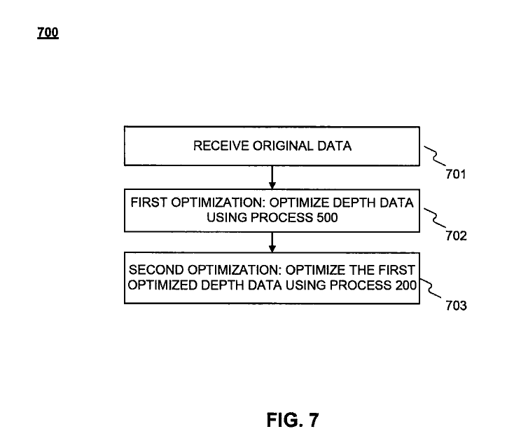

FIG. 7 shows a flow chart of an exemplary process for refining a depth image using the simulation circuit model followed by a separate optimization operation using saliency constraints. Compared to process 600, process 700 combines process 200 and process 500 sequentially. For example, after the original data is received in step 701, a first optimization operation of the depth data may be performed with respect to the saliency constraints, e.g., according to process 500. In step 703, the second optimization operation may be performed using a simulation circuit model, e.g., according to process 200. Consistent with some embodiments, the optimized results of the first optimization operation are treated as input of original data to a second optimization operation. For example, the optimized depth data obtained in step 702 are converted to simulation voltage signals and assigned to the data nodes of the simulation circuit model. Process 700 may conclude after step 703.

Although process 700 is described that step 702 is performed before step 703, it is contemplated that order of these two steps may be switched. By performing the two optimization operations sequentially and independently, the benefits of diffusion current constraint and the saliency constraints are taken advantage of without restrictions by each other.

Although the above descriptions are made in connection with refining a depth map of a three-dimensional image, it is contemplated that the disclosed systems and methods can be adapted for various other applications. For example, the processes described in connection with FIGS. 2 and 5-7 may be readily applied to refine a sparse correspondence of the depth map. In some cases, the depth map may include only a subset of pixels that carry significant information and the rest of the pixels may carry only nominal depth information. Consistent with some embodiments, only the pixels that carry significant information (i.e., a sparse correspondence of the depth map) may be included in calculating the one or more energy terms that are described above. As a result, computational complexity for solving the unknowns may be reduced, without losing much important information in the depth map.

It will be apparent to those skilled in the art that various modifications and variations can be made in the disclosed embodiments without departing from the scope or spirit of those disclosed embodiments. Other embodiments of the invention will be apparent to those skilled in the art from consideration of the specification. It is intended that the specification and examples be considered as exemplary only, with a true scope and spirit of the disclosed embodiments being indicated by the following claims.

What is claimed is:

1. A computer-implemented method for refining a three-dimensional image, comprising:
identifying a depth image of the three-dimensional image;
establishing a simulation circuit model by a processor, the simulation circuit model comprising data nodes, diffusion nodes and connection devices, the connection devices connecting the data nodes and the diffusion nodes, the simulation circuit model assigning emulation voltage signals to the data nodes corresponding to at least a portion of the data points in the depth image, the assigned emulation voltage signals being substantially correlated to depth data of the at least a portion of the data points;
applying, by the processor, an optimization operation to generate diffused voltage signals for the diffusion nodes due to at least a redistribution of at least some of the emulation voltage signals to the diffusion nodes through the connection devices; and
updating the depth data of the depth image based on the diffused voltage signals.

2. The method of claim 1, wherein optimizing further includes at least one of reducing or minimizing a first energy associated with diffusion current signals of the connection devices.

3. The method of claim 2, wherein updating the depth data further includes iteratively updating the depth data until the first energy is smaller than a first energy threshold.

4. The method of claim 2, further comprising:
determining resistance values associated with the connecting devices; and
generating the diffused current signals based on emulation voltage signals, the diffused voltage signals, and the resistant values.

5. The method of claim 2, wherein at least a portion of the first energy is further associated with at least one of a depth constraint, a distortion constraint, and an edge bending constraint.

6. The method of claim 5, wherein the portion of the first energy associated with the diffused current signals is assigned a first weight, and the portion of the first energy associated with the at least one of the depth constraint, the distortion constraint, and the edge bending constraint is assigned a second weight, wherein the method further comprising:
determining the first weight and the second weight by analyzing the three-dimensional synthetic image.

7. The method of claim 1, further comprising:
modifying the depth data of the depth image based on at least one of a depth constraint, a distortion constraint, and an edge-bending constraint,
wherein the emulation voltage signals assigned to the data nodes are substantially correlated to the optimized depth data.

8. The method of claim 7, wherein modifying includes at least one of reducing or minimizing a second energy associated with the at least one of the depth constraint, the distortion constraint, and the edge bending constraint.

9. A computer-implemented method for refining a three-dimensional image, comprising:
identifying a depth image of the three-dimensional image;
determining, by a processor, an energy including a first energy portion corresponding to a depth constraint, a second energy portion corresponding to a distortion constraint, and a third energy portion corresponding to an edge bending constraint, wherein the depth constraint, the distortion constraint, and the edge bending constraint are each a function of depth data of the depth image; and
applying, by the processor, an optimization operation to refine the depth data of the depth image by at least one of reducing minimizing the energy.

10. The method of claim 9, wherein determining the energy further includes weighing the first energy portion, the second energy portion, and third energy portion with distinct weights.

11. The method of claim 9, wherein optimizing the depth data further includes iteratively updating the depth data until the energy is smaller than a first energy threshold.

12. The method of claim 9, wherein the depth constraint is associated with a difference between refined depth data, and a combination of axis data and initial depth data.

13. A system for refining a three-dimensional image, comprising:
a storage device storing a depth image of the three-dimensional image, the depth image comprising a depth data; and
a processor coupled with the storage device and configured to:
establish a simulation circuit model, the simulation circuit model comprising data nodes, diffusion nodes and connection devices, the connection devices connecting the data nodes and the diffusion nodes, the simulation circuit model assigning emulation voltage signals to the data nodes corresponding to at least a portion of the data points in the depth image, the assigned emulation voltage signals being substantially correlated to depth data of the at least a portion of the data points;
apply an optimization operation to generate diffused voltage signals for the diffusion nodes due to at least a redistribution of at least some of the emulation voltage signals to the diffusion nodes through the connection devices; and
update the depth data of the depth image based on the diffused voltage signals.

14. The system of claim 13, wherein the diffused voltage signals are optimized by at least one of reducing or minimizing a first energy associated with diffusion current signals of the connection devices.

15. The system of claim 14, wherein at least a portion of the first energy is further associated with at least one of a depth constraint, a distortion constraint, and an edge bending constraint.

16. The system of claim 13, wherein the processor is further configured to:
modify the depth data of the depth image based on at least one of a depth constraint, a distortion constraint, and an edge bending constraint,
wherein the emulation voltage signals assigned to the data notes are substantially correlated to the optimized depth data.

17. A non-transitory computer-readable medium with an executable program stored thereon, wherein the program instructs a processor to perform the following for refining a three-dimensional image:
identifying a depth image of the three-dimensional image;
establishing a simulation circuit model, the simulation circuit model comprising data nodes, diffusion nodes and connection devices, the connection devices connecting the data nodes and the diffusion nodes, the simulation circuit model assigning emulation voltage signals to the data nodes corresponding to at least a portion of the data points in the depth image, the assigned emulation voltage signals being substantially correlated to depth data of the at least a portion of the data points;
applying an optimization operation to generate diffused voltage signals for the diffusion nodes due to at least a redistribution of at least some of the emulation voltage signals to the diffusion nodes through the connection devices; and
updating the depth data of the depth image based on the diffused voltage signals.

18. A system for refining a three-dimensional image, comprising:
a storage device storing a depth image of the three-dimensional image, the depth image comprising a depth data; and
a processor coupled with the storage device and configured to:
determine an energy including a first energy portion corresponding to a depth constraint, a second energy portion corresponding to a distortion constraint, and a third energy portion corresponding to an edge bending constraint, wherein the depth constraint, the distortion constraint, and the edge bending constraint are each a function of depth data of the depth image; and
apply an optimization operation to refine the depth data of the depth image by at least one of reducing or minimizing the energy.

19. A non-transitory computer-readable medium with an executable program stored thereon, wherein the program instructs a processor to perform the following for refining a three-dimensional image:
identifying a depth image of the three-dimensional image;
determining an energy including a first energy portion corresponding to a depth constraint, a second energy portion corresponding to a distortion constraint, and a third energy portion corresponding to an edge bending constraint, wherein the depth constraint, the distortion constraint, and the edge bending constraint are each a function of depth data of the depth image; and
applying an optimization operation to refine the depth data of the depth image by at least one of reducing or minimizing the energy.
